(19) United States
(12) Patent Application Publication
(10) Pub. No.: US 2006/0095709 A1
(43) Pub. Date: May 4, 2006

(54) Storage system management method and device

(76) Inventor: Kyosuke Achiwa, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/022,782

(22) Filed: Dec. 28, 2004

(30) Foreign Application Priority Data
Nov. 4, 2004 (JP) 2004-321015

(51) Int. Cl. G06F 12/00

(52) U.S. Cl. 711/173; 711/114; 711/162

(57) ABSTRACT

Inconveniences such as a manager erroneously deleting data in the secondary volume, or deleting the setting itself of the secondary volume in an SLPR storage system can be prevented. All LDEV information regarding all SLPR managed by a manager is acquired (S171). The user ID and password of the SLPR management table for secondary LDEV are designated, the SLPR for secondary LDEV is designated for the SLPR number, and notified to the maintenance terminal (S172). All LDEV information of all SLPR is displayed as a list (S173). Primary LDEV is selected from a pair management table (S174). Whether the manager is an SLPR manager for secondary LDEV, subsystem manager, or SLPR manager is checked (S175). Those having the same size and RAID level as the primary LDEV are displayed as a list (S176). The secondary LDEV is selected (S177), a local replication pair generation command is issued with the user ID and password of the subsystem manager from the secondary LDEV and primary LDEV, and a pair of the primary LDEV and secondary LDEV is created (S179).

### CROSS-REFERENCE TO PRIOR APPLICATION

This application relates to and claims priority from Japanese Patent Application No. 2004-321015 filed on Nov. 4, 2004 the entire disclosure of which is incorporated herein by reference.

### BACKGROUND OF THE INVENTION

1. Field of the Invention

The present invention relates to a storage system having a plurality of partitions containing storage devices and management method of the storage system.

2. Background of the Invention

Conventionally, in a disk array where data are mirrored in two LUs for acquiring snapshots later time to be used as a backup, a method has been proposed for constituting the respective Array Groups having a storage area of original data and a storage area to be provided as a snapshot as disk structures of nD+1P having mutually different n, such that the respective Array Groups can adopt mutually flexible constitutions. With this method, provided are a mirror source LU as the storage area on a plurality of disk drives constituted with nD+1P; a mirror destination LU as the storage area on a plurality of disk drives constituted with mD+1P; an n-RAID control sub program for performing RAID control of nD+1P; an m-RAID control sub program for performing RAID control of mD+1P; and an LU mirroring sub program which duplicates written data from a host computer to both the mirror source LU and mirror destination LU. Incidentally, m and n are integral numbers of 2 or greater, and m and n are different values (for example, c.f. Japanese Patent Laid-Open Publication No. 2002-259062).

Meanwhile, with respect to storage systems, technology referred to as SLPR (Storage Logical Partition) is known. SLPR is an application of logical partition (LPR) technology of mainframe computers, which virtually partitions a single mainframe computer and enables the use of such single computer as though a plurality of computers exists, to storage systems. In other words, SLPR is a system of logically partitioning ports and LDEVs (logical volume) inside the storage system to make a single storage system seem as though there are a plurality of storage systems to the users (i.e., SLPR managers), and a SLPR manager is only able to view or operate the SLPR ports and LDEVs which he owns.

In a storage system employing this kind of SLPR technology, there are cases when a secondary volume of the ShadowImage, which is snapshot technology employing so-called split-resynchronization of mirrored volumes, stores important data even when such secondary volume is not assigned to a host computer. Nevertheless, as a result of the secondary volume not being assigned to the host computer, the SLPR manager may misunderstand that secondary volumes of the ShadowImage are volumes not being used, and inadvertently delete the data stored in such secondary volumes. Further, when the foregoing manager wants a new volume so that he can store new data, there is also a problem in that the secondary volume tends to be assigned to a host computer although the volume contains important data.

In order to prevent the secondary volume from being assigned to a host computer for storing new data, this can be realized by making the secondary volume a read-only volume, or providing a setting such that it will not be subject to I/O; that is, so that it will not be accessed for the reading of data or writing of data. Nevertheless, the foregoing method is not able to prevent the foregoing manager from misunderstanding that the secondary volume of the ShadowImage is a volume not being used, and inadvertently deleting the volume itself or the data stored in such secondary volume.

### SUMMARY OF THE INVENTION

Accordingly, an object of the present invention is to overcome inconveniences such as a manager erroneously deleting data in volumes employed as the secondary volumes of mirrored volumes, or deleting the the secondary volumes themselves in a storage system logically partitioned and formed with a plurality of partitions containing ports and volumes.

The storage system management device according to the first perspective of the present invention comprises: a first setting unit for setting first partitions containing active volumes among the plurality of partitions of a storage system formed by logically partitioning the storage system; a second setting unit for setting a second partition containing secondary volumes and candidates of secondary volumes capable of forming (ShadowImage) pairs with primary volumes, with the active volumes as the primary volumes, among the plurality of partitions; a volume information acquisition unit for acquiring information pertaining to volumes contained in the plurality of partitions; a determination unit for determining whether the volume is a candidate of a secondary volume contained in the second partition from the information of the volume acquired by the volume information acquisition unit; and a pair creation unit for extracting a volume capable of making the volume determined by the determination unit as being contained in the second partition become the secondary volume among the volumes contained in the first partitions, and creating a pair with the volume as the primary volume and the determined volume as the secondary volume thereof.

In a preferable embodiment pertaining to the first perspective of the present invention, an access inhibition unit for inhibiting any I/O access to candidates of the secondary volumes contained in the second partition is further provided.

In another embodiment, none of the volumes contained in the first partitions are used as the secondary volumes.

Further, in another embodiment, a manager judgement unit for judging whether the manager of the storage system is a higher-level manager capable of managing all of the respective partitions, or a lower-level manager capable of managing only a specific partition among the respective partitions is further provided.

Moreover, in another embodiment, when the manager judgement unit judges the manager of the storage system to be the higher-level manager or the manager of the second partition, the pair creation unit entrusts him with the selection, from the second partition, of the volumes to be the secondary volumes of the ShadowImage pair volumes.

Further, in another embodiment, the extraction of the volume to be the primary volume from the first partitions is conducted by the top manager.

Moreover, in another embodiment, when the manager judgement unit judges the manager of the storage system to be the lower-level manager, the pair creation unit automatically conducts the selection, from the second partition, of the volume to be the secondary volume of the ShadowImage pair volume.

Further, in another embodiment, only the manager of the second partition performs the processing of assigning the volume made to be the secondary volume contained in the second partition to a host computer which read/write data to/from the volume, and the processing of canceling such assignment (i.e., removing the access path).

The storage system management device according to the second perspective of the present invention comprises: a first setting unit for setting first partitions containing active volumes among the plurality of partitions of a storage system formed by logically partitioning the storage system; a second setting unit for setting a second partition for accommodating, as the secondary volumes, volumes forming (ShadowImage) pairs with primary volumes, with the active volumes as the primary volumes, among the plurality of partitions;

a volume information acquisition unit for acquiring information pertaining to volumes contained in the plurality of partitions excluding the second partition; a judgement unit for judging whether there is a volume forming a pair with an active volume among the volumes contained in the plurality of partitions excluding the second partition from the information of the volume acquired by the volume information acquisition unit; and a volume transfer unit for transferring a volume judged by the judgement unit to be forming a pair as the secondary volume to the second partition when the active volume is made to be the primary volume.

The storage system management method according to the third perspective of the present invention comprises: a first step of setting first partitions containing active volumes among the plurality of partitions of a storage system formed by logically partitioning the storage system; a second step of setting a second partition containing secondary volumes and candidates of a secondary volumes capable of forming a pair with primary volumes, with the active volumes as the primary volumes, among the plurality of partitions; a third step of acquiring information pertaining to a volume contained in the plurality of partitions; a fourth step of judging whether the volume is a candidate of the secondary volume contained in the second partition from the information of volume acquired in the third step; and a fifth step of extracting a volume capable of making the volume judged in the fourth step as being contained in the second partition become the secondary volume with the volume contained in the first partition, and creating a pair with the volume as the primary volume and the judged volume as the secondary volume thereof.

### BRIEF DESCRIPTION OF THE DRAWINGS

FIG. 1 is a block diagram showing an example of the information processing system comprising the storage system employing the SLPR (Storage Logical Partition) technology according to the present invention, and a plurality of host computers under the jurisdiction of the respective users;

FIG. 2 is an explanatory diagram showing the management operation of the maintenance terminal and management computer in relation to the storage system employing the SLPR technology according to the present invention;

FIG. 3 is a block diagram showing the overall constitution of the information processing system employing the SLPR technology in the storage system pertaining to an embodiment of the present invention;

FIG. 4 is a block diagram showing the internal constitution of each CHA illustrated in FIG. 3;

FIG. 5 is a block diagram showing the internal constitution of each DKA illustrated in FIG. 3;

FIG. 6 is a block diagram showing the internal constitution of the maintenance terminal illustrated in FIG. 3;

FIG. 7 is an explanatory diagram showing an example of the port partition table pertaining an embodiment of the present invention;

FIG. 8 is an explanatory diagram showing an example of the LDEV partition table pertaining to an embodiment of the present invention;

FIG. 9 is an explanatory diagram showing an example of the LDEV management table pertaining to an embodiment of the present invention;

FIG. 10 is an explanatory diagram showing an example of the storage manager management table pertaining to an embodiment of the present invention;

FIG. 11 is an explanatory diagram showing an example of the storage manager management table (A) included in the storage management software loaded in the management computer described in FIG. 1 and FIG. 2, respectively;

FIG. 12 is an explanatory diagram showing an example of the pair management table pertaining to an embodiment of the present invention;

FIG. 13 is an explanatory diagram showing an example of the administrator management table pertaining to an embodiment of the present invention;

FIG. 14 is an explanatory diagram showing an example of the SLPR management table for the secondary LDEV pertaining to an embodiment of the present invention;

FIG. 15 is an explanatory diagram showing the content of communication conducted between the management computer and maintenance terminal pertaining to an embodiment of the present invention;

FIG. 16 is a flowchart showing the processing routine to be executed when the maintenance terminal pertaining to an embodiment of the present invention receives the LDEV information request command from the management computer;

FIG. 17 is a flowchart showing the processing routine to be executed when the maintenance terminal pertaining to an embodiment of the present invention receives the local replication pair generation command from the management computer;

FIG. 18 is a flowchart showing the pair creation processing routine to be implemented when the administrator pertaining to an embodiment of the present invention is to create a local replication pair;

FIG. 19 is a flowchart showing the processing routine to be executed when the maintenance terminal pertaining to another embodiment of the present invention receives the LDEV transfer command from the management computer;

FIG. 20 is a flowchart showing the pair creation processing routine to be implemented when the administrator pertaining to another embodiment of the present invention is to create a local replication pair; and

FIG. 21 is a flowchart showing the processing routine of the secondary LDEV transfer processing pertaining to another embodiment of the present invention.

### DETAILED DESCRIPTION OF THE PREFERRED EMBODIMENTS

Embodiments of the present invention are now explained in detail with reference to the drawings.

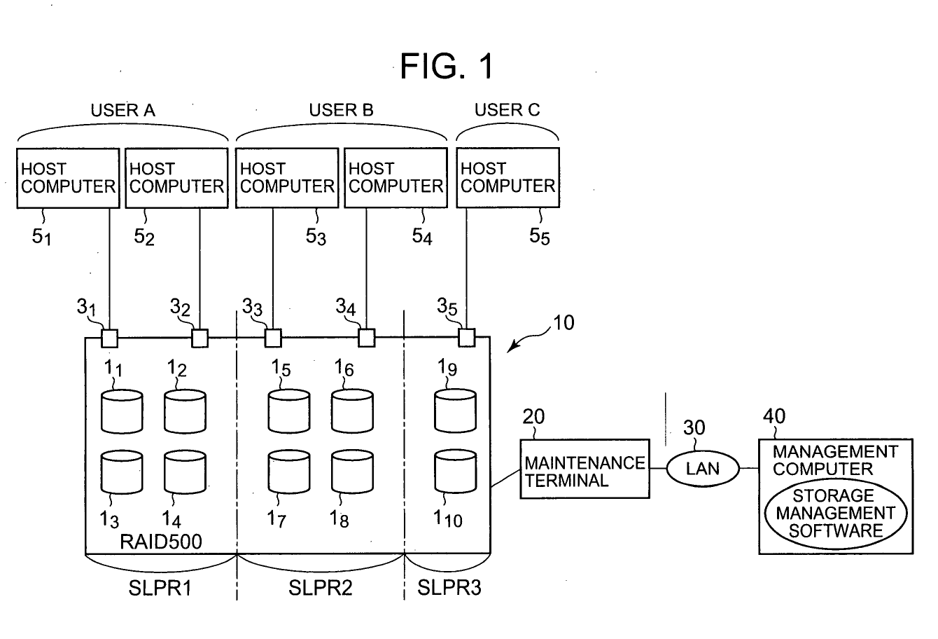

FIG. 1 is a block diagram showing an example of the information processing system comprising the storage system employing the SLPR (Storage Logical Partition) technology according to the present invention, and a plurality of host computers under the jurisdiction of the respective users.

With the storage system depicted in FIG. 1, the description of a disk control device (disk controller) (including a channel control unit, shared memory cache memory, disk control unit, management terminal and connection unit), which constitutes the storage system together with disk drives, is omitted. Therefore, here, the detailed explanation regarding CLPR (Cache Memory Logical Partition) is omitted.

As shown in FIG. 1, with SLPR, a storage system 10 in which a plurality of hard disk drives (HDD) is constituted as RAID (Redundant Arrays of Independent/Inexpensive Disks) is partitioned into several sections (partitions) including LDEV (logical devices) 1₁ to 1₁₀, and ports 3₁ to 3₅, and the respective sections (partitions) are handled as the virtually independent storage systems SLPR1, SLPR2, and SLPR3. With the information processing system shown in FIG. 1, the two host computers 5₁, 5₂ under the jurisdiction of user A access SLPR1, respectively; the two host computers 5₃, 5₄ under the jurisdiction of user B access SLPR2, respectively; and the two host computers 5₅, 5₆ under the jurisdiction of user C access SLPR3, respectively.

In SLPR1, port 3₁ is a port for receiving I/Os from user A's host computer 5₁; and port 3₂ is a port for receiving I/Os from user A's host computer 5₂. Next, in SLPR2, port 3₃ is a port for receiving I/Os from user B's host computer 5₃; and port 3₄ is a port for receiving I/Os from user B's host computer 5₄. Further, in SLPR3, port 3₅ is a port for receiving I/Os from user C's host computer 5₅.

An SVP (Service Processor) 20 is connected to the storage system 10, and the SVP 20 is connected to the management computer 40 via the LAN (Local Area Network) 30. The SVP 20 is a PC (personal computer) for performing the maintenance and management operations of the storage system 10; that is, it is a maintenance terminal (SVP is hereinafter referred to as a “maintenance terminal”). The maintenance terminal 20 is able to manage all LDEVs (1₁ to 1₁₀) and all ports 3₁ to 3₅ (within the storage system 10) by the manager operating the maintenance terminal 20 logging in as the manager of the storage system; in other words, as the subsystem manager.

Meanwhile, for example, if the manager of user A logs in as the partition manager of SLPR1 (i.e., SLPR manager who is a manager operating the maintenance terminal 20 as with the foregoing subsystem manager), the maintenance terminal 20 is only able to manage the ports 31, 32 contained in SLPR1, and the LDEV1₁ to 1₄ contained in SLPR1. Further, for example, if the manager of user B logs in as the partition manager of SLPR2 (i.e., SLPR manager), the maintenance terminal 20 is only able to manage the ports 3₃, 3₄ contained in SLPR2, and the LDEV1₅ to 1₈ contained in SLPR2. Moreover, for example, if the manager of user C logs in as the partition manager of SLPR3 (i.e., SLPR manager), the maintenance terminal 20 is only able to manage the port 3₅ contained in SLPR3, and the LDEV1₉ to 1₁₀ contained in SLPR3.

The management computer 40 is a terminal such as a PC loaded with storage management software, and this storage management software operates in the management computer 40.

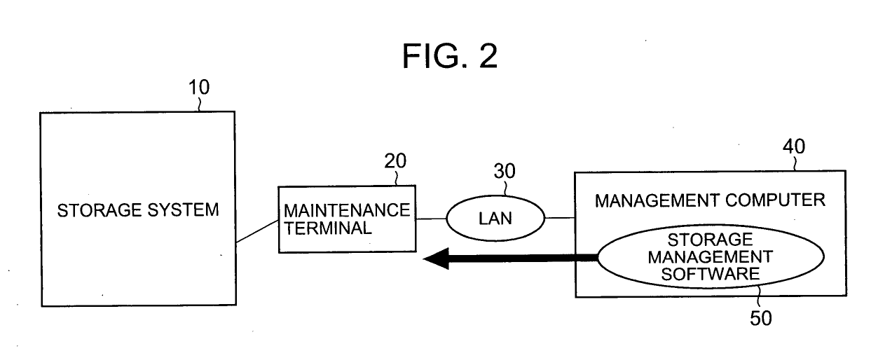

FIG. 2 is an explanatory diagram showing the management operation of the maintenance terminal and management computer in relation to the storage system employing the SLPR technology according to the present invention.

As explained in FIG. 1, with the storage system employing the SLPR technology pertaining to the present invention, three types of managers; namely, the subsystem manager who is the manager operating the maintenance terminal 20 and can manage all ports and LDEVs in the subsystem; the SLPR manager who is also the manager operating the maintenance terminal 20, but can manage only ports and LDEVs that are in his own SLPR; and the administrator who is the manager operating the management computer 40, are able to manage the storage system.

The subsystem manager is a person (operator) who manages the storage system 10 by operating the maintenance terminal (20), and is able to manage the LDEVs (1₁ to 1₁₀) and ports (3₁ to 3₅) contained in all partitions (SLPR1, SLPR2, and SLPR3) constituting the storage system (10). The subsystem manager is also able to set the partitions (SLPR1 to SLPR3) in the storage system 10.

As with the subsystem manager described above, the SLPR manager is also a manager (operator) who operates the maintenance terminal (20). Nevertheless, the SLPR manager, unlike the subsystem manager, is only able to view and manage the LDEVs and ports (e.g., LDEV1₁ to 1₄ and ports 3₁, 3₂) contained in the partition that he personally manages (e.g., SLPR1 if such SLPR manager is the manager of SLPR1), and is not able to view or manage the other LDEVs or ports.

The administrator is a manager (operator) who operates the storage management software 50 loaded in the management computer 40 by operating the management computer 40.

In FIG. 2, by logging in to the storage management software 50 in the management computer 40, the administrator is able to perform management operations to the storage system 10. In this management operation, the storage management software 50 loaded in the management computer 40 issues a command (API; Application Programming Interface) to the maintenance terminal 20 via the LAN 30. Upon the storage management software 50 issuing the command (API) to the maintenance terminal 20, it is necessary to add the subsystem manager's user ID and password, or the SLPR manager's user ID and password to such command. And, this command is executed with the maintenance terminal 20 pursuant to the added authority of the manager (subsystem manager or SLPR manager).

Incidentally, the SLPR manager or subsystem manager, by logging onto the maintenance terminal 20, operates the maintenance terminal 20 for managing the respectively corresponding (i.e., his) SLPR (one among SLPR1 to 3), or the storage system 10.

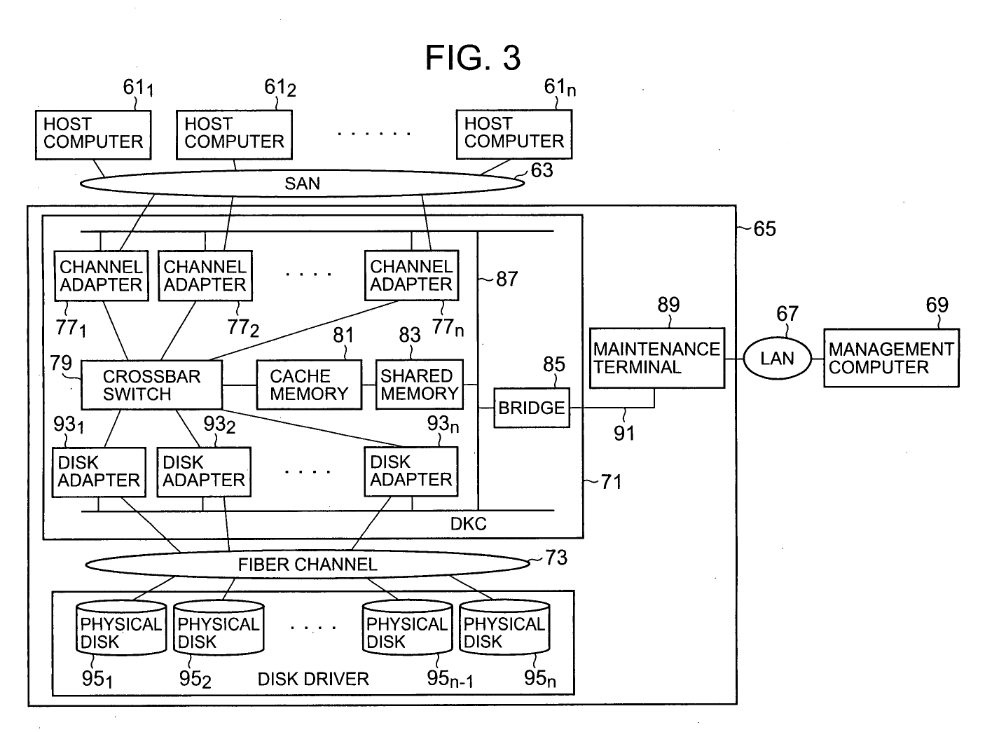

FIG. 3 is a block diagram showing the overall constitution of the information processing system employing the SLPR technology in the storage system pertaining to an embodiment of the present invention.

As shown in FIG. 3, the information processing system has a plurality of host computers 61₁ to 61ₙ, a SAN (Storage Area Network) 63, a storage system 65, a LAN 67, and a management computer 69. The storage system 65 has a disk controller, or DKC 71, a (back end) Fibre Channel 73, a plurality of physical disks (PDEVs) 95₁ to 95ₙ (disk driver [symbol] [symbol] physical disks [symbol] [symbol] [symbol] [symbol] [symbol] a maintenance terminal 89, and an internal LAN 91. The DKC 71 has a plurality of channel adapters (CHA) 77₁ to 77ₙ, a crossbar switch 79, cache memory (CM) 81, shared memory (SM) 83, a bridge 85, a shared bus 87, and disk adapters 93₁ to 93ₙ.

In FIG. 3, each host computer 61₁ to 61ₙ is a computer comprising of information processing resources such as CPU (Central Processing Unit) or memory; and, for instance, a personal computer, workstation or mainframe is employed as the host computer 61₁ to 61ₙ. Each host computer 61₁ to 61ₙ has an information input device (not shown) such as a keyboard, pointing device or microphone, and an information output device (not shown) such as a monitor display or speaker. Each host computer 61₁ to 61ₙ, in addition to each of the foregoing components, further has an application program (not shown) such as database software using the storage area (physical disks 95₁ to 95ₙ) provided by the storage system 65; and an adapter (not shown) for accessing the storage system 65 via the SAN 63.

Although each host computer 61₁ to 61ₙ is connected to the storage system 65 via the SAN 63, as the communication network for connecting each host computer 61₁ to 61ₙ and the storage system 65, in addition to the SAN 63, for instance, a LAN, Internet, dedicated line, or public (telephone) line may be suitably used according to the situation. In the present embodiment, since a Fibre Channel SAN (63) is used as the communication network, each host computer 61₁ to 61ₙ requests the input and output of data to the DKC 71 with a block, which is a fixed-size (e.g., 512 bytes each) data management unit of the storage area provided by a plurality of physical disks, as the unit, according to the Fibre Channel protocol.

Incidentally, when a LAN is to be used as the communication network, data communication via the LAN, for instance, will be conducted according TCP/IP (Transmission Control Protocol/Internet Protocol). Each host computer 61₁ to 61ₙ designates a file name and requests the input and output of data in the unit of file to the DKC 71 (of the storage system 65). Further, the foregoing adaptor (not shown) is a host bus adaptor (HBA) for example when the SAN is used as the communication network as in the present embodiment, and the foregoing adaptor (not shown) is a LAN-compliant network card (NIC; Network Interface Card) for example when the LAN is used as the communication network. Moreover, the foregoing data communication can also be conducted via the iSCSI protocol.

In DKC 71, each CHA 77₁ to 77ₙ is for conducting data transfer with each host computer 61₁ to 61ₙ, and has one or more communication ports (description thereof is omitted in FIG. 3), respectively, for communicating with each host computer 61₁ to 61ₙ. Each CHA 77₁ to 77ₙ is constituted as a computer having a CPU and memory, respectively, and interprets and executes various I/O requests received from each host computer 61₁ to 61ₙ. Further, a network address (e.g., IP address or WWN) for identifying the respective channels is assigned to each port on CHA 77₁ to 77ₙ. Thus, as shown in FIG. 3, when there is a plurality of host computers (61₁ to 61ₙ), each port on CHA 77₁ to 77ₙ is able to independently receive requests from each host computer 61₁ to 61ₙ.

Each disk adapter (DKA) 93₁ to 93ₙ is for exchanging data between DKC71 and the physical disks 95₁ to 95ₙ via the Fibre Channel 73, and has one or more Fibre Channel ports (description thereof is omitted in FIG. 3), respectively, for connecting with the physical disks 95₁ to 95ₙ. Each DKA 95₁ to 95ₙ is constituted as a computer having a CPU and memory. Data which is received by CHA 77₁ to 77ₙ from a host computer 61₁ to 61ₙ through SAN 63 is transferred to cache memory 81 via the connection unit; that is, a crossbar switch 79. And DKA 95₁ to 95ₙ reads the data from the cache memory 81 through the crossbar switch 79 and writes the data to target address (LBA; Logical Block Address) of target volume located in physical disks 95₁ to 95ₙ via the Fibre Channel 73.

Each DKA 93₁ to 93ₙ also reads data from a target address of the target volume located in physical disks 95₁ to 95ₙ via the Fibre Channel 73 based on the request (writing command) from a host computer 61₁ to 61ₙ and stored the data to cache memory 81 via the crossbar switch 79. Then CHA 77₁ to 77ₙ reads the data from cache memory 81 through the crossbar switch 79, and transmits to the host computer 61₁ to 61ₙ which issued the read request. Incidentally, when each DKA 93₁ to 93ₙ is to perform read or write data with the volumes placed in physical disks 95₁ to 95ₙ via the Fibre Channel 73, the logical address is converted into a physical address. Further, when each DKA 93₁ to 93ₙ performs data access to a RAID volume dispersed in physical disks 95₁ to 95ₙ, the physical to logical address conversion will be done according to the RAID configuraion.

The cache memory (CM) 81 temporarily stores the data provided from each CHA 77₁ to 77ₙ via the crossbar switch 79, wherein each CHA 77₁ to 77ₙ received such data from each host computer 61₁ to 61ₙ. Together with this, the CM 81 temporarily stores data provided from each DKA 93₁ to 93ₙ via the crossbar switch 79, wherein each DKA 93₁ to 93ₙ read such data from each volume (physical disk) 95₁ to 95ₙ via the Fibre Channel 73. Incidentally, instead of CM 81, one or a plurality of the volumes located in high performance physical disks 95₁ to 95ₙ may be used as the cache disk (CM) for the CM 81.

The shared memory (SM) 83 is connected, via the shared bus 87, to each CHA 77₁ to 77ₙ, each DKA 93₁ to 93ₙ and the bridge 85. Control information and the like is stored in the SM 83, and, in addition to various tables such as the mapping table being stored therein, it can be used as work area.

The bridge 85 is placed between and connects the internal LAN 91 and the shared bus 87, and is required when the maintenance terminal 89 accesses the SM 83 via the internal LAN 91 and shared bus 87.

The crossbar switch 79 is for mutually connecting each CHA 77₁ to 77ₙ, each DKA 93₁ to 93ₙ, and CM 81, and the crossbar switch 79, for example, may be constituted as a high-speed bus such as a ultra-fast crossbar switch for performing data transmission pursuant to a high-speed switching operation.

The maintenance terminal 89, as described above, is connected to the bridge 85 via the internal LAN 91, and connected to the management computer 69 via the LAN 67, respectively.

As a volume, for example, in addition to physical disks such as hard disks or flexible disks, various devices such as magnetic tapes, semiconductor memory, and optical disks may be used. Several LDEVs; that is, logical volumes (or logical devices) are formed from the plurality of physical disks.

The management computer 69 is a terminal such as a PC for running the storage management software 50 described above.

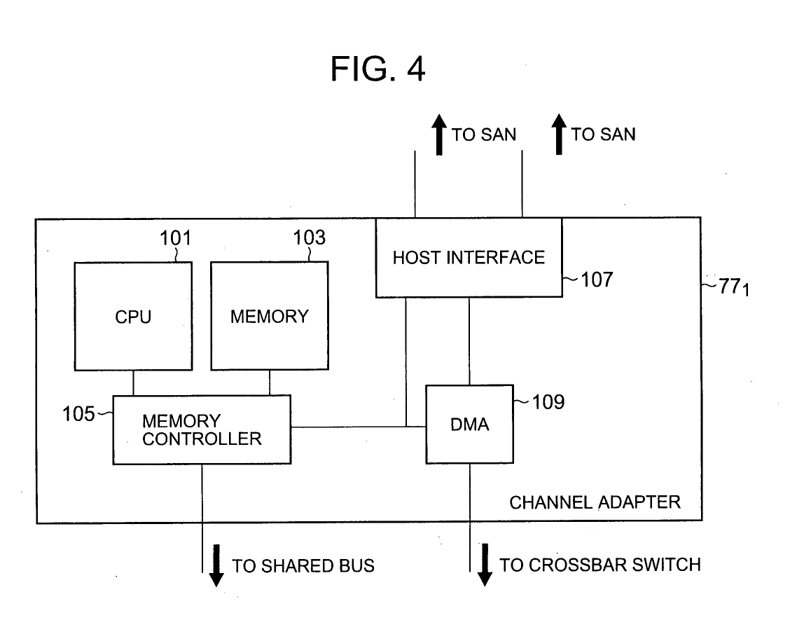

FIG. 4 is a block diagram showing the internal structure of each channel adapter (CHA) (77₁ to 77ₙ) illustrated in FIG. 3. Since the structure of each CHA (77₁ to 77ₙ) is the same, the following explanation is made taking the structure of CHA 77₁ as an example.

CHA 77₁ is constituted as a single unit board having one or a plurality of circuit boards, and, as shown in FIG. 4, such circuit board is provided with a CPU 101, memory 103, a memory controller 105, a host interface (host I/F) 107, and a DMA (Direct Memory Access) 109.

The host I/F 107 has a dual port Fibre Channel chip which contains SCSI (Small Computer System Interface) protocol controller, as well as two FC ports. The host I/F 107 functions as a communication interface for communicating with each host computer (61₁ to 61ₙ). The host I/F 107, for example, receives I/O requests transmitted from the host computer (61₁ to 61ₙ) or controls the transmission and reception of data according to the Fibre Channel protocol.

The memory controller 105, under the control of the CPU 101, communicates with the DMA 109 and host I/F 107. In other words, the memory controller 107 receives read requests of data stored in the physical disks 95₁ to 95ₙ, or write requests to the physical disks 95₁ to 95ₙ from the host computers (61₁ to 61ₙ) via the port of the host I/F 107. And, it further exchanges data and exchanges commands with the DKA 93₁ to 93ₙ, CM 81, SM 83, and maintenance terminal 89.

The DMA 109 is for performing DMA transfer between the host I/F 107 and CM (81) via the crossbar switch 79, and the DMA 109 executes the transfer of the data transmitted from the host computers (61₁ to 61ₙ) shown in FIG. 3 or the transmission of data stored in the CM 81 to the host computers (61₁ to 61ₙ) based on the instruction from the CPU 101 provided via the memory controller 105.

In addition to the memory 103 being provided with firmware for the CPU 101 of the CHA 77₁, the memory 103 is used as the work area for the CPU 101.

The CPU 101 controls the respective components of the CHA 77₁.

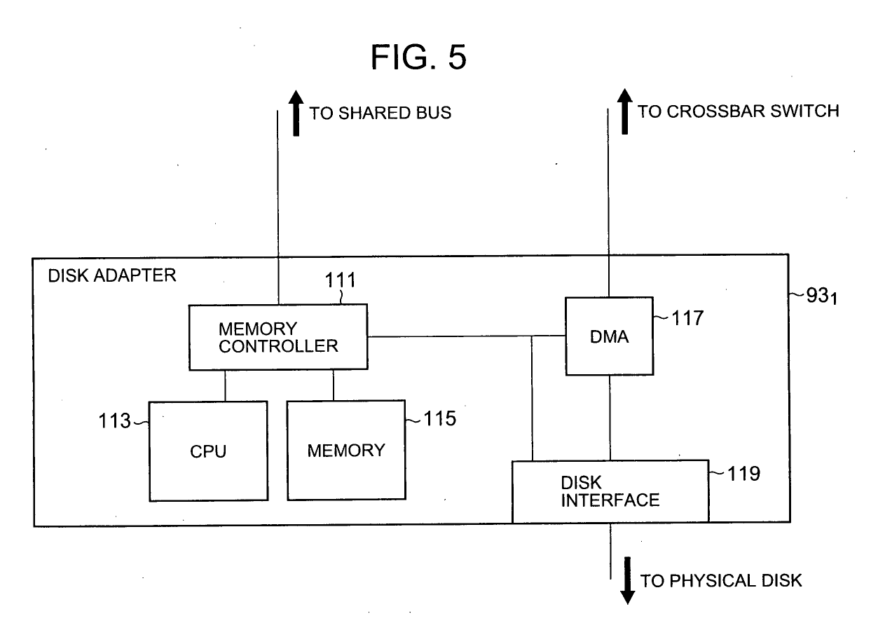

FIG. 5 is a block diagram showing the internal structure of each disk adapter (DKA) (93₁ to 93ₙ) illustrated in FIG. 3. Since the internal structure of each DKA (93₁ to 93ₙ) is the same, the following explanation is made taking the internal structure of DKA 93₁ as an example.

The DKA 93₁, as shown in FIG. 5, has a memory controller 111, a CPU 113, memory 115, a DMA 117, and a disk interface (disk I/F) 119, and these are formed integrally as a unit.

The disk I/F 119 has a single port Fibre Channel chip which has SCSI protocol controller. The disk I/F 119 functions as a communication interface for communicating with the physical disks.

The DMA 117 performs the DMA transfer between the disk I/F 119 and CM 81 via the crossbar switch 79 based on the command provided from the CPU 113 via the memory controller 111. The DMA 117 also functions as the communication interface between the CHA 77, and cache memory 81.

The memory controller 111, under the control of the CPU 113, communicates with the DMA 117 and disk I/F 119.

In addition to the memory 115 being provided with firmware for the CPU 133 of the DKA 931, the memory 115 is used as the work area for CPU 113.

The CPU 113 controls the respective components of the DKA 931.

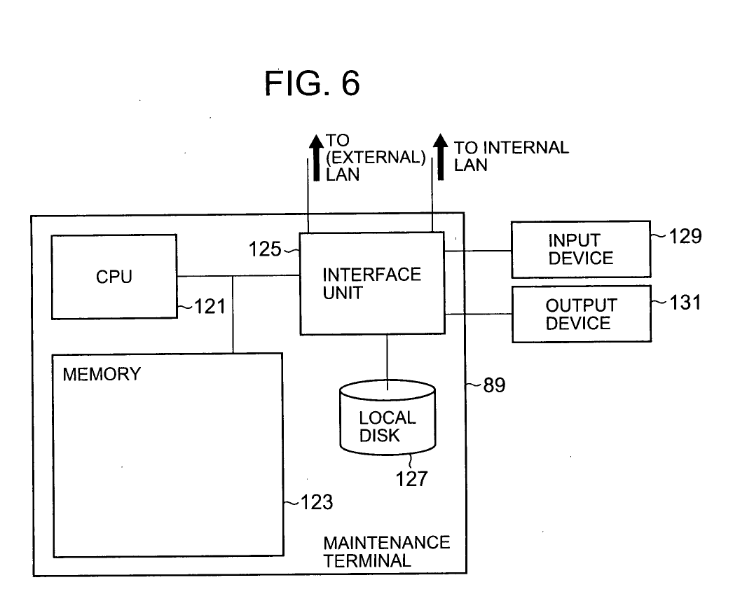

FIG. 6 is a block diagram showing the internal structure of the maintenance terminal 89 illustrated in FIG. 3.

The maintenance terminal 89, as described above, is for accessing the various management tables on the SM 83 via the internal LAN 91, bridge 85, and shared bus 87, and, for example, is a PC for activating an OS such as US Microsoft's Windows (registered trademark). The maintenance terminal 89, as shown in FIG. 6, has a CPU 121, memory 123, an interface unit 125, and a local disk 127.

The memory 123 stores the OS and other programs and non-volatile fixed data required for the maintenance terminal 89 to perform maintenance and management operations to the storage system 65. The memory 123 outputs the foregoing fixed data to the CPU 121 according to the data read out request from the CPU 121. Incidentally, reproductions of the various management tables stored in the SM 83 may also be stored in the memory 123. In this case, (the CPU 121 of) the maintenance terminal 89 does not have to access the SM 83 each time it is necessary to refer to the various management tables.

Connected to the interface unit 125 are an internal LAN 91, an (external) LAN 67, an input device 129 such as a keyboard or a mouse, an output device 131 such as a display, and a local disk 127. The input device 129 is directly operated by a manager (of the maintenance terminal 89) (i.e., a subsystem manager or SLPR manager) when such manager is to perform the maintenance or management operation of the storage system 65 via the maintenance terminal 89. When the reproduction of the various management tables is not stored in the memory 123, the interface unit 125, under the control of the CPU 121, accesses the SM 83 via the internal LAN 91, bridge 85, and shared bus 87, and refers to the various management tables stored in the SM 83. The interface unit 125, under the control of the CPU 121, receives the management commands issued by the management computer 69 to the maintenance terminal 89 and transmitted via the (external) LAN 67.

The CPU 121 controls the respective components of the maintenance terminal 89.

Incidentally, the local disk 127 is an auxiliary storage medium in the maintenance terminal 89.

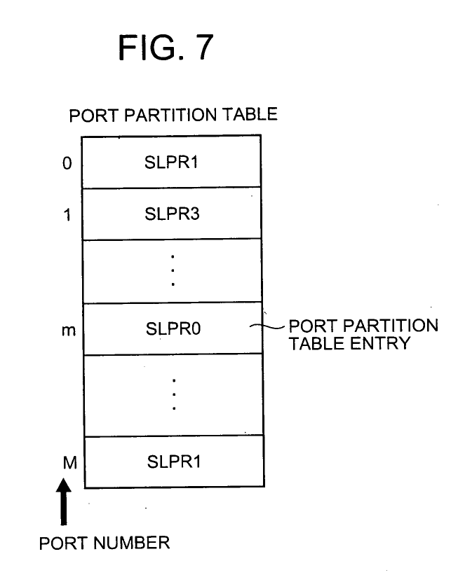

FIG. 7 is an explanatory diagram showing an example of the port partition table pertaining an embodiment of the present invention. The port partition table exists on the SM.

The port partition table shown in FIG. 7 is a table having information for showing to which partition (SLPR1 to SLPR3) each port (3₁ to 3₅) contained in the storage system 10 depicted in FIG. 1 belongs, and this table is stored in the SM 83 (of the DKC 71). The contents entered in the port partition table shown in FIG. 7 are as follows. In other words, 0, 1, . . . m, . . . , M represent the number of each port (port number) contained in the storage system 10, and SLPR1, SLPR3, . . . , SLPR0, . . . and SLPR1 represent the SLPR number corresponding to each port number, respectively. In the example shown in FIG. 7, port 0 belongs to SLPR1, port 1 belongs to SLPR3, port m belongs to SLPR0, and port M belongs to SLPR1, respectively.

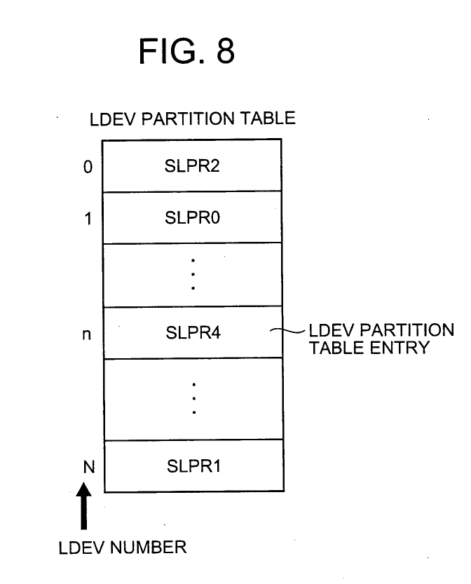

FIG. 8 is an explanatory diagram showing an example of the LDEV partition table pertaining to an embodiment of the present invention. The LDEV partition table exists on the SM.

The LDEV partition table shown in FIG. 8 is a table having information for showing to which partition (SLPR1 to SLPR3) each LDEV (Logical Device; i.e., Logical Disk) contained in the storage system 10 shown in FIG. 1 belongs, and this table is stored in the SM 83 of (the DKC 71). The contents entered in the LDEV partition table shown in FIG. 8 are as follows. In other words, 0, 1, . . . , n, . . . , N represent the number of each LDEV (LDEV number) contained in the storage system 10, and SLPR2, SLPR0, . . . , SLPR4, . . . , SLPR1 represent the SLPR number corresponding to each LDEV number, respectively. In the example shown in FIG. 8, LDEV0 belongs to SLPR2, LDEV1 belongs to SLPR0, LDEVn belongs to SLPR4, and LDEVN belongs to SLPR1.

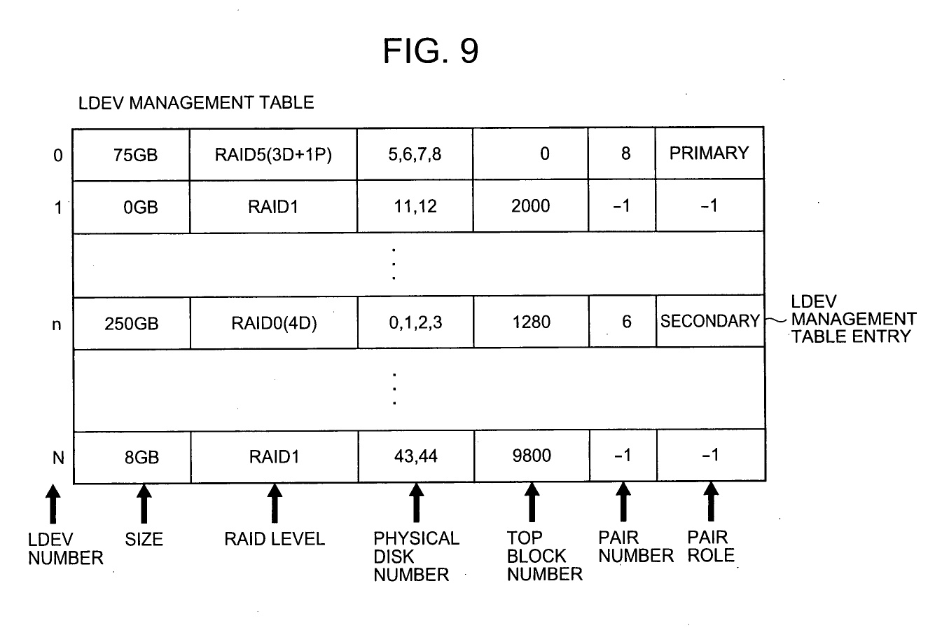

FIG. 9 is an explanatory diagram showing an example of the LDEV management table pertaining to an embodiment of the present invention. The LDEV management table exists on the SM.

The LDEV management table shown in FIG. 9 is a table having information relating to each LDEV (1₁ to 1₁₀) contained in the storage system 10 shown in FIG. 1, and this table is stored in the SM 83 (of the DKC 71). The contents entered in the LDEV management table shown in FIG. 9 are as follows. In other words, 0, 1, . . . , n, . . . , N represent the number of each LDEV (LDEV number) contained in the storage system 10, and 75 GB, 0 GB, . . . , 250 GB, . . . , 8 GB represent the size (memory capacity) of each LDEV, respectively. Further, RAID5 (3D+1P), RAID1, RAID0 (4D), RAID1 represent the RAID level of each LDEV, 5, 6, 7, 8, 11, 12, . . . , 0, 1, 2, 3, . . . , 43, 44 represent the number of each physical disk (physical disk number) containing each LDEV, and 0, 2000, . . . , 1280, . . . , 9800 represent the top block number within each physical disk. Further, 8, −1, . . . , 6, . . . , −1 represent the pair number of the local replication pair, and primary, −1, . . . , secondary, . . . , −1 represent the pair role (explained later).

In the example shown in FIG. 9, the LDEV in which the LDEV number is 0 (i.e., LDEV0) has a size (memory capacity) of 75 GB, and a RAID level of RAID5 (3D+1P). This LDEV (in which the LDEV number is 0) occupies 25 GB each (100 GB including the parity data with the four physical disks 5, 6, 7, 8) from the top blocks of the physical disks 5, 6, 7, 8 (the top block number of each physical disk 5, 6, 7, 8 is 0). This LDEV (in which the LDEV number is 0) is a primary volume with the pair number being 8.

Next, the LDEV in which the LDEV number is 1 (i.e., LDEV1) implies that the size (memory capacity) thereof is 0 GB, or does not exist. Therefore, information on the LDEV (in which the LDEV number is 1) regarding the RAID level, physical disk number, top block number, pair number, and pair role will be meaningless.

Next, when the pair number and pair role in the LDEV in which the LDEV number is N (i.e., LDEVN) are both −1, this implies that the LDEV (in which the LDEV number is N) does not constitute a local replication pair.

Incidentally, in each LDEV in which the LDEV number is 0, 1, . . . , n, . . . , N, the pair role “primary” means the LDEV constitutes the primary LDEV, the pair role “secondary” means it constitutes the secondary LDEV, and the pair role “−1” means it does not constitute a pair, respectively.

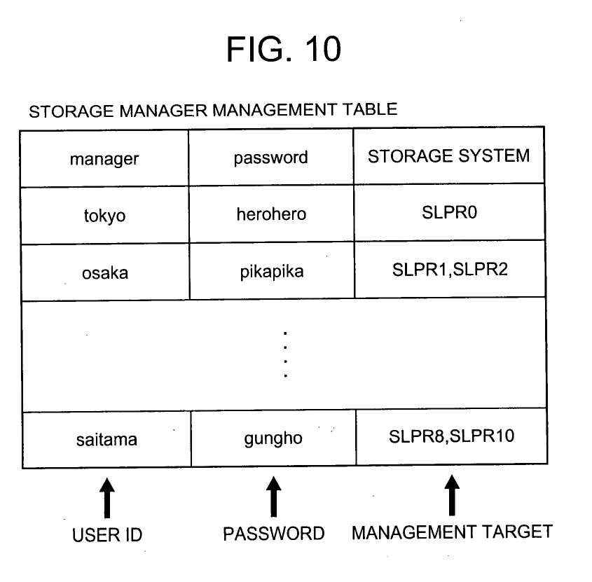

FIG. 10 is an explanatory diagram showing an example of the storage manager management table pertaining to an embodiment of the present invention.

The storage manager management table shown in FIG. 10 is a table showing the user ID and password of the subsystem manager/SLPR manager, and which SLPR/subsystem is being managed, and this table is stored in the SM 83 (of the DKC 71). In the storage manager management table shown in FIG. 10, tokyo, osaka, . . . , saitama are stored as the user ID (i.e., manager); herohero, pikapika, . . . , gungho are stored as the password; and storage system, SLPR0, SLPR1, SLPR2, . . . , SLPR8, SLPR10 are stored as the management target, respectively. With the storage manager management table shown in FIG. 10, if the management target is the storage system, the manager operating the maintenance terminal 20 is the subsystem manager, and, in other cases, the manager operating the maintenance terminal 20 is the SLPR manager. For example, in the manager operating the maintenance terminal 20, the password of the manager (SLPR manager) in which the user ID is osaka is pikapika, and this SLPR manager manages SLPR1 and SLPR2.

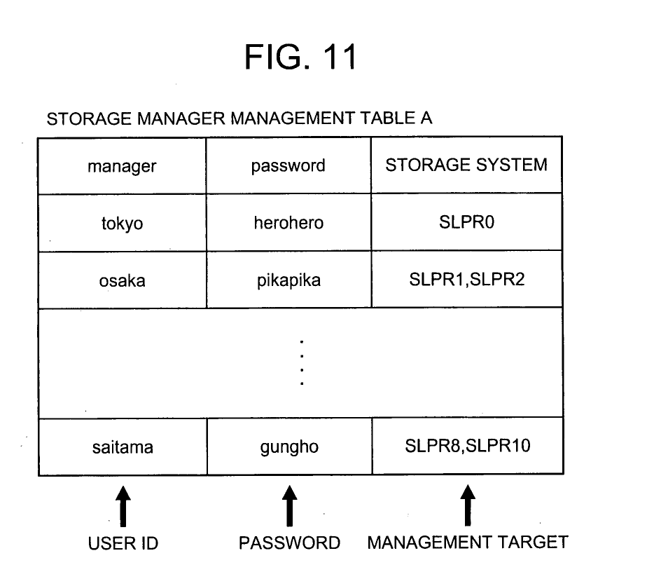

FIG. 11 is an explanatory diagram showing an example of the storage manager management table (A) included in the storage management software 50 loaded in the management computer 40 described in FIG. 1 and FIG. 2, respectively.

As evident upon comparing FIG. 11 and FIG. 10, the storage manager management table (in the storage management software 50) illustrated in FIG. 11 and the storage manager management table (A) (stored in the SM 83 (of the DKC 71)) shown in FIG. 10 are the same.

The storage manager management table (A) has information required for the storage management software 50 to issue a command to the maintenance terminal 20.

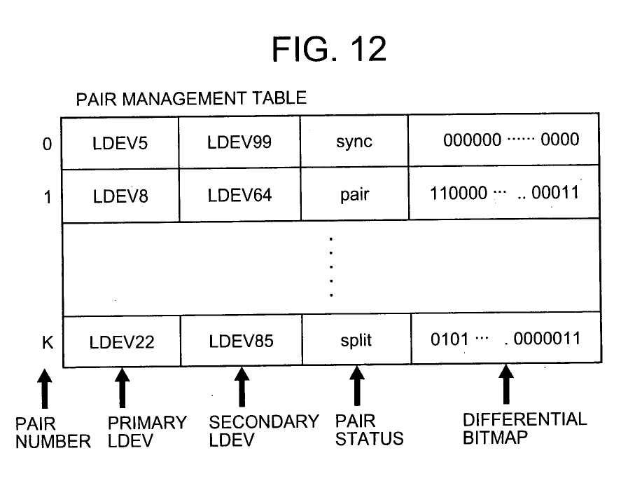

FIG. 12 is an explanatory diagram showing an example of the pair management table pertaining to an embodiment of the present invention.

The pair management table shown in FIG. 12 is a management table of a local replication (what we call Shadow Image) pair, and this table is stored in the SM 83 (of the DKC 71). In this pair management table, 0, 1, . . . , K indicate the pair number; LDEV5, LDEV8, . . . , LDEV22 are stored as the primary LDEV; LDEV99, LDEV64, . . . , LDEV85 are stored as the secondary LDEV; and sync, pair, . . . , split are stored as the pair status. Further, 000000 . . . 0000, 110000 . . . 00011, . . . , 0101 . . . 0000011 are stored as the differential bitmap.

In this pair management table, contained as the type of pair status in addition to sync, pair and split shown in FIG. 12, resync and reverse are also contained therein. Sync is a state where the data stored in the primary LDEV and secondary LDEV completely coincide, and, in sync, the data writing request from the host computer (5₁ to 5₅) to the storage system (10) is reflected against both the primary and secondary LDEV. Pair is a state where the data stored in the primary LDEV and secondary LDEV has no conformity whatsoever, and, therefore, the value of the differential bitmap is meaningless. Split is a state where the secondary LDEV is “freezed.” In split, the differential of the data stored in the primary LDEV and the data stored in the secondary LDEV is managed with the differential bitmap. Incidentally, the data writing request from the host computer (5₁ to 5₅) to the storage system (10) will only be reflected against the primary LDEV. Resync is a state where the differential data stored in the primary LDEV is being copied to the secondary LDEV, and when such copying of the differential data is complete, the state of resync changes to the state of sync. Reverse is a state where, contrary to resync, the differential data stored in the secondary LDEV is being copied to the primary LDEV, and when such copying of the differential data is complete, the state of reverse changes to the state of sync.

Incidentally, a differential bitmap is a bitmap for representing the differential between the data stored in the primary LDEV and the data stored in the secondary LDEV. In the differential bitmap, one logical block in the LDEV is represented with 1 bit, when a given logical block in the primary LDEV and a given logical block in the secondary LDEV corresponding to such logical block coincide, this is represented as “0”, and when they do not coincide, this is represented as “1”.

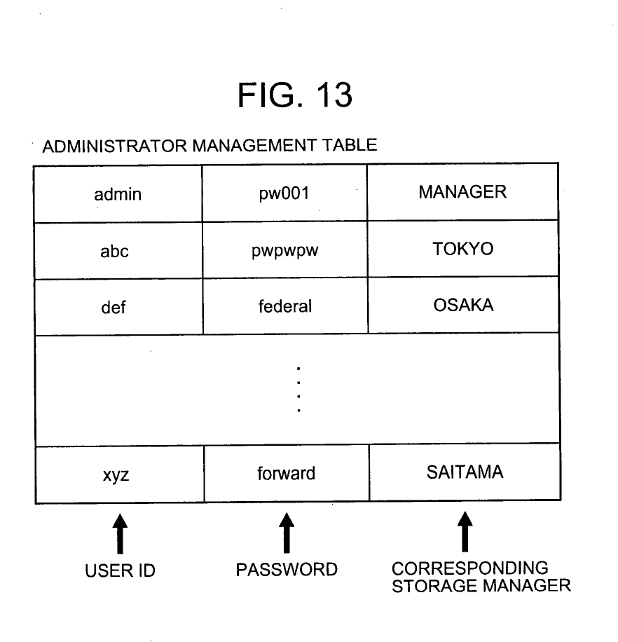

FIG. 13 is an explanatory diagram showing an example of the administrator management table pertaining to an embodiment of the present invention.

The administrator management table shown in FIG. 13 is a table for managing the administrators; that is, the persons (managers) using the storage management software (50); in other words, the operators of the management computer (40). Details of the administrator have been described in FIG. 2. The storage management software (50) in the management computer (40) has the administrator management table. This table has information items such as the user ID, password and the corresponding storage manager for the administrator, and these information are used upon logging on to the storage management software (50). Information such as admin, abc, def, . . . , xyz is registered in the user ID; information such as pw01, pwpwpw, federal, . . . , forward is registered in the password; and information such as manager, tokyo, osaka, . . . , saitama is registered in the corresponding storage manager, respectively.

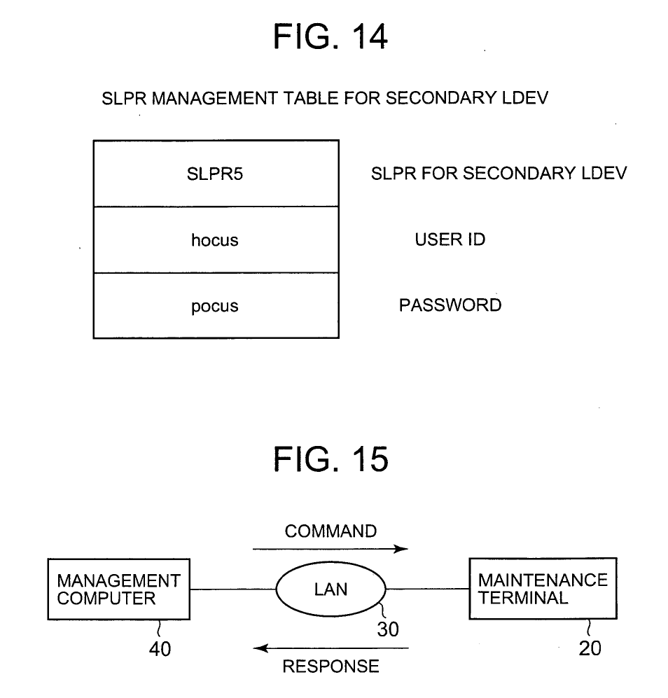

FIG. 14 is an explanatory diagram showing an example of the SLPR management table for the SLPR having secondary LDEVs pertaining to an embodiment of the present invention.

The storage management software (50) in the management computer (40) has the SLPR management table for secondary LDEV shown in FIG. 14, as with the administrator management table shown in FIG. 13. This table has information items such as the SLPR for secondary LDEVs, user ID, and password. SLPR5 is registered as the SLPR for secondary LDEVs, hocus is registered as the user ID, and pocus is registered as the password, respectively.

FIG. 15 is an explanatory diagram showing the content of communication conducted between the management computer (40) and maintenance terminal (20) pertaining to an embodiment of the present invention.

As evident from the foregoing description, a command issued by the management computer 40 is transmitted from the management computer 40 to the maintenance terminal 20. And then, a response as a result of the command is transmitted from the maintenance terminal 20 to the management computer 40.

For example, the command transmitted from the management computer 40 to the maintenance terminal 20 via the LAN 30 may be an LDEV information request command. Attached to this LDEV information request command (“GetLdevInfo”), are the user ID of the subsystem manager or the user ID of the SLPR manager as the user ID, and the password to be used upon logging onto the maintenance terminal (20) as the password, and information on the SLPR number corresponding desired LDEVs information, respectively. Incidentally, when LDEVs information pertaining to all the SLPRs in the storage system is desired, the SLPR number will be designated as “all”.

Meanwhile, in the response to be transmitted from the maintenance terminal 20 to the management computer 40 in response to the LDEV information request command, all LDEV information contained in the SLPR (SLPR number) designated with the management computer 40 attached to the LDEV information request command is in a format according to the format of the LDEV management table shown in FIG. 9. Needless to say, when the SLPR (SLPR number) designated with the LDEV information request command is not being managed with the user ID designated with the LDEV information request command, an error will be transmitted as the response from the maintenance terminal 20 to the management computer 40.

As the foregoing response, series of information pertaining to a specific LDEV, such as the LDEV number, size (of LDEV) (memory capacity), RAID level, physical disk number, physical disk number, physical disk number, . . . , top block number, pair number and pair role is transmitted from the maintenance terminal 20 to the management computer 40 for the number of LDEVs designated in the LDEV information request command. Incidentally, since the number of the physical disk numbers listed will change depending on the RAID level (RAID5 (3D+1P)), the number of physical disk numbers to be listed can be sought by checking the RAID level.

In the present embodiment, in addition to the foregoing LDEV information request command, the local replication pair generation command is also used.

Attached to this local replication pair generation command (“CreatePair”) are user ID information, password information, primary LDEV number information, secondary LDEV number information, and so on. As the response to this local replication pair generation command, there are “Succeeded” and “Failed”.

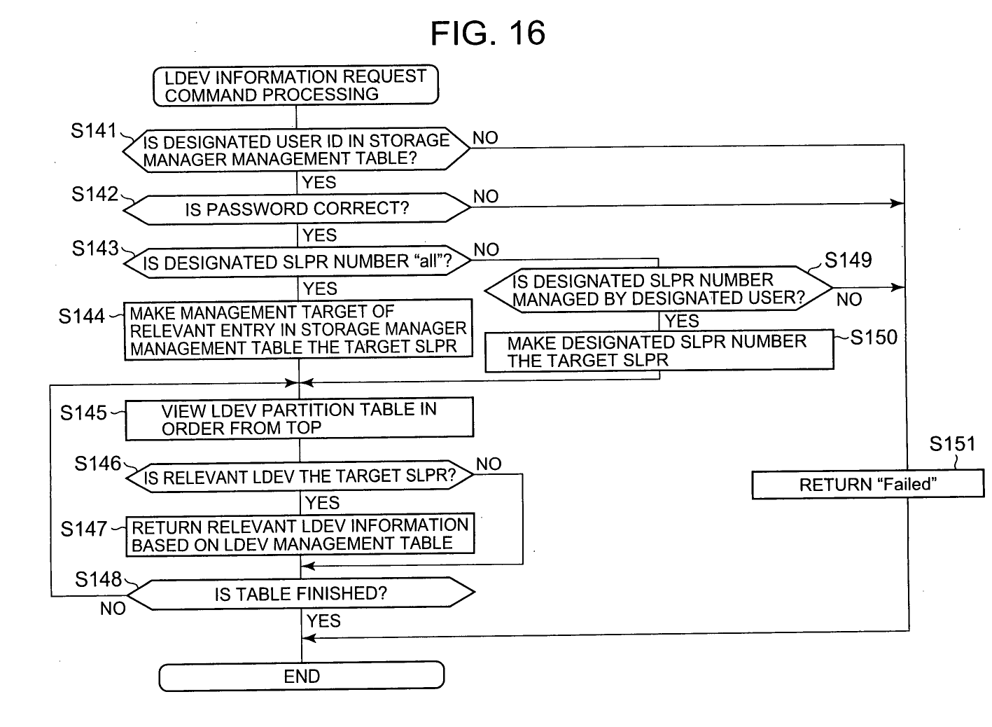

FIG. 16 is a flowchart showing the processing routine to be executed when the maintenance terminal (indicated with reference numeral 89 in FIG. 6; hereinafter the same) pertaining to an embodiment of the present invention receives the LDEV information request command from the management computer (indicated with reference numeral 69 in FIG. 6; hereinafter the same).

In FIG. 16, foremost, the CPU (indicated with reference numeral 121 in FIG. 6; hereinafter the same) of the maintenance terminal 89 checks whether the designated user ID attached to the LDEV information request command from the management computer 69 is in the storage manager management table (stored in the SM 83 (of the DKC 71)) shown in FIG. 10, or in the storage manager management table (A) (of the storage management software 50) shown in FIG. 11 (step S141). As a result of this check, when it is judged as existing (Yes in step S141), subsequently, the password attached to the LDEV information request command is checked to see if it is in the storage manager management table (or storage manager management table (A)) (step S142). As a result of this check, when it is judged as existing (Yes in step S142), subsequently, the designated SLPR number attached to the LDEV information request command is checked to see if it is “all” (step S143).

As a result of this check, when it is judged as being “all” (Yes in step S143), all SLPR entered in the storage manager management table (or storage manager management table (A)) is made to be the management target. Here, if the storage manager is a subsystem manager, all SLPR in the storage system (65) will become a management target (step S144).

Next, the CPU 121 of the maintenance terminal 89 refers to all SLPR entered in the LDEV partition table shown in FIG. 8 in order from the top of the table (step S145). And, by accessing the SM 83 (of the DKC 71), it checks to see whether the LDEV currently subject to checking belongs to SLPR that is a management target from the LDEV number information held by the table and the independent SLPR information entered in the table in correspondence to each LDEV number information (step S146). As a result of this check, when it is judged that the LDEV subject to checking belongs to SLPR that is a management target (Yes in step S146), the CPU 121 (of the maintenance terminal 89) transmits to the management computer 69 the information pertaining to such LDEV (LDEV information) in a format according to the format of the LDEV management table (stored in the SM 83 (of the DKC 71)) (step S147).

As a result of checking the designated SLPR number attached to the LDEV information request command, if it is judged as not being “all” (No in step S143), the SLPR number designated with the LDEV information request command is checked to see whether it is to be managed by a manager (designated manager) designated in the storage manager management table (or storage manager management table (A)) (step S149). As a result of this check, when it is judged that the designated SLPR number is to be managed by the designated user (Yes in step S149), the SLPR pertaining to the designated SLPR number information is transferred to the processing routine shown in step S145 as the SLPR of the management target (step S150). Incidentally, when the designated user is a subsystem manager, the routine proceeds to the processing routine shown in step S150.

When it is judged that the LDEV currently subject to checking does not belong to the SLPR which is a management target from the LDEV number information held by the LDEV partition table and the independent SLPR information entered in the table corresponding to each LDEV number information (No in step S146), the routine immediately proceeds to the processing routine shown in step S148.

The processing routine from step S145 to step S147 is repeated up to the end of the LDEV partition table (No in step S148), and, when it is judged that the routine reached the end, the series of LDEV information request command processing steps will end. Incidentally, when it is judged as No at all steps of step S141, step S142 and step S149, (the CPU 121 of) the maintenance terminal 89 transmits Failed as the response to the management computer 69 (step S151), and the series of LDEV information request command processing steps will end.

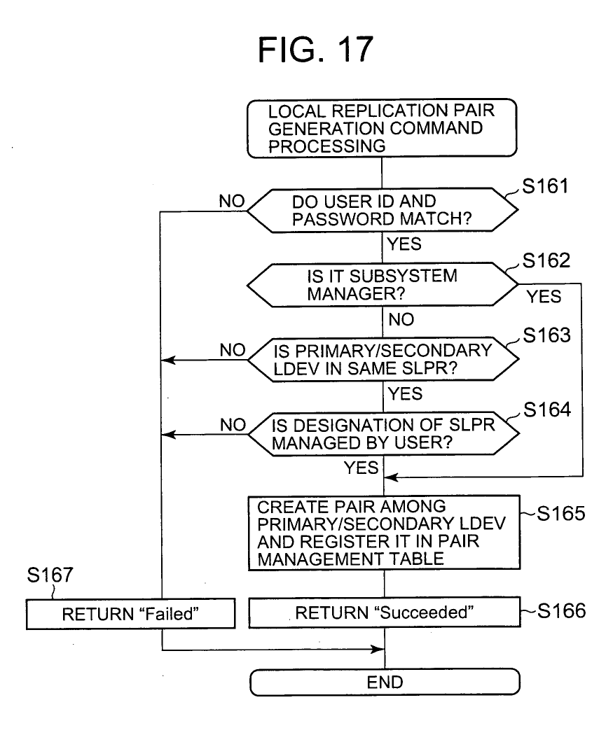

FIG. 17 is a flowchart showing the processing routine to be executed when the maintenance terminal 89 pertaining to an embodiment of the present invention receives the local replication pair generation command from the management computer 69.

In FIG. 17, foremost, the CPU 121 of the maintenance terminal 89 refers to the storage manager management table (stored in the SM 83 (of the DKC 71)) shown in FIG. 10, or the storage manager management table (A) (held by the storage management software 50) shown in FIG. 11, and checks to see whether the designated user ID and password from the management computer 69 attached to the LDEV information request command are in the storage manager management table (or storage manager management table (A)) (step S161). As a result of this check, when it is judged as existing (Yes in step S161), subsequently, the storage manager is checked to see if such manager is a storage manager from the user ID attached to the LDEV information request command (step S162). As a result of this check, when it is judged that the storage manager is not a subsystem manager from the user ID attached to the LDEV information request command (No step S162), the routine proceeds to the processing routine shown in subsequent step S163.

Next, the CPU 121 of the maintenance terminal 89, as a result of accessing the SM 83 (of the DKC 71), refers to all SLPR entered in the LDEV partition table shown in FIG. 10 in order from the top of the table, and checks to see whether the primary LDEV and secondary LDEV are in the same SLPR (Incidentally, in the present embodiment, the SLPR manager (explained in FIG. 2) is not able to combine a pair of the primary LDEV and secondary LDEV across different SLPR; that is, by stepping over SLPR.)) (step S163). As a result of this check, when it is judged that the primary LDEV and secondary LDEV are in the same SLPR (Yes in step S163), subsequently, it is checked to see whether such (target) SLPR is to be managed by the manager (designated user) designated in the storage manager management table (or storage manager management table (A)) (step S164). As a result of this check, when it is judged that this SLPR is to be managed by the designated user (Yes in step S164), a pair is created with the primary LDEV and secondary LDEV, and the created pair is registered in the pair management table stored in the SM 83 (of the DKC 71) shown in FIG. 12 (step S165). And, the maintenance terminal 89 sends Succeeded to the management computer 69 as a response to the local replication pair generation command (step S166), and the series of local replication pair creation command processing steps will end. Explanation regarding the processing for actually creating the local replication pair or the processing for copying the created local replication pair in step S165 is omitted.

When it is judged that the storage manager is a subsystem manager from the user ID attached to the LDEV information request command (Yes in step S162), the routine immediately proceeds to the routine processing shown in step 165. Unlike the SLPR manager, the subsystem manager is not subject to any restrictions for pairing the primary LDEV and secondary LDEV across different SLPR; that is, by stepping over SLPR.

Incidentally, when it is judged as No at all steps of step S161, step S163, and step S164, (the CPU 121) of the maintenance terminal 89 transmits Failed as the response to the management computer 69 (step S167), and the series of local replication pair creation command processing steps will end.

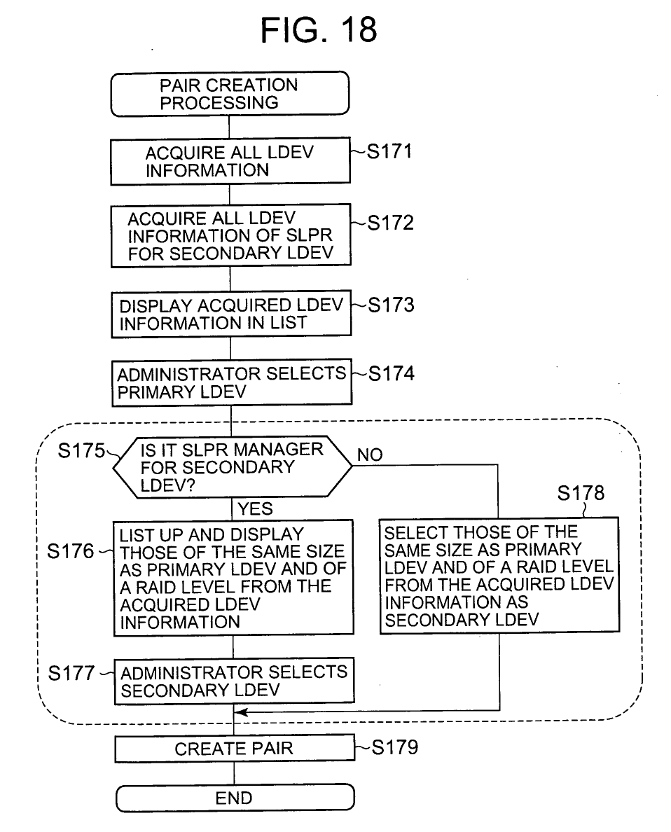

FIG. 18 is a flowchart showing the pair creation processing routine to be implemented when the administrator pertaining to an embodiment of the present invention is to create a local replication pair. The pair creation processing shown in FIG. 18 is performed by the administrator executing this with the storage management software loaded on the management computer 69.

In FIG. 18, foremost, the administrator implements processing for acquiring all LDEV information regarding all SLPR managed by the storage manager corresponding to such administrator. In other words, management computer 69, upon transmitting the LDEV information request command to the maintenance terminal 89, designates the user ID and password in the user management table (storage manager management table/storage manager management table (A)) with GetLdevInfo, designates “all” to the SLPR number, and notifies such designated contents to the maintenance terminal 89. As a result, with (the number information of) the SLPR registered as the management target in the user management table (storage manager management table/storage manager management table (A)) as the key, the LDEV number information corresponding to (the number information of) the SLPR in the LDEV partition table shown in FIG. 8 is searched and acquired. Further, with such LDEV number information as the key, as a result of searching and acquiring information pertaining to LDEV corresponding to the LDEV number information from the LDEV management information table shown in FIG. 9, all LDEV information can be acquired (step S171).

Next, the administrator designates the user ID and password in the SLPR management table for secondary LDEV shown in FIG. 14 with GetLdevInfo, designates SLPR for secondary LDEV for the SLPR number, notifies these designated contents to the maintenance terminal 89, and then implements processing for acquiring all LDEV information regarding the SLPR registered as a management target in the SLPR management table for secondary LDEV. In other words, the management computer 69 searches and acquires the LDEV number information corresponding to (the number information of) the SLPR from the LDEV partition table shown in FIG. 8 with (the number information of) the SLPR registered as the SLPR for secondary LDEV in the SLPR for secondary LDEV shown in FIG. 14 as the key. Further, with such LDEV number information as the key, as a result of searching and acquiring information pertaining to LDEV corresponding to the LDEV number information from the LDEV management information table shown in FIG. 9, all LDEV information can be acquired (step S172)

Next, the administrator lists all LDEV information regarding all SLPR managed by the storage manager corresponding to the administrator acquired in step S171, and, for example, displays this on a display (not shown) of the management computer 69. Here, the LDEV information contained in the SLPR for secondary LDEV acquired in step S172 is not displayed (step S173).

Next, the administrator, for example, refers to the pair management table stored in the SM 83 (of the DKC 71) shown in FIG. 12 and selects the primary LDEV (step S174).

With the processing routine shown in step S175 through step S178 explained below, only the LDEV contained in the SLPR registered as the SLPR for secondary LDEV in the SLPR management table for secondary LDEV shown in FIG. 14 will become the candidate of the secondary LDEV. Among the storage managers, although the SLPR manager for secondary LDEV including subsystem managers may select the secondary LDEV, since storage managers (i.e., SLPR manager) other than those described above will not be allowed to view the LDEV in the SLPR for secondary LDEV, the secondary LDEV will be automatically selected.

Next, the administrator checks to see whether the storage manager is an SLPR manager for secondary LDEV, or a subsystem manager, or a storage manager (i.e., SLPR manager) other than the above. This check is conducted by the administrator referring to the storage manager management table shown in FIG. 10, or the storage manager management table (A) shown in FIG. 11 (step S175). As a result of this check, when it is judged that the storage manager is either the SLPR manager for secondary LDEV or the subsystem manager (Yes in step S175), the administrator creates a list for those having the same size as the primary LDEV and same level as the RAID level among the LDEV information acquired in step S171, step S172, and, for example, displays this on a display (not shown) of the management computer 69 (step S176).

Next, the administrator selects the secondary LDEV from the foregoing list (step S177), issues a local replication pair generation command with the user ID and password (registered in the storage manager management table shown in FIG. 10 or FIG. 11) of the subsystem manager from the selected secondary LDEV and the selected step S174, and creates the pair of the primary LDEV and secondary LDEV (step S179). As a result, the series of pair creation processing steps will end.

Meanwhile, when it is judged that the storage manager is neither the SLPR manager for secondary LDEV or the subsystem manager (No in step S175), the administrator selects as the secondary LDEV the item which first matches the primary LDEV regarding the size and RAID level from the information acquired in step S171, step S172 (step S178), and the routine proceeds to the processing routine shown in step S179.

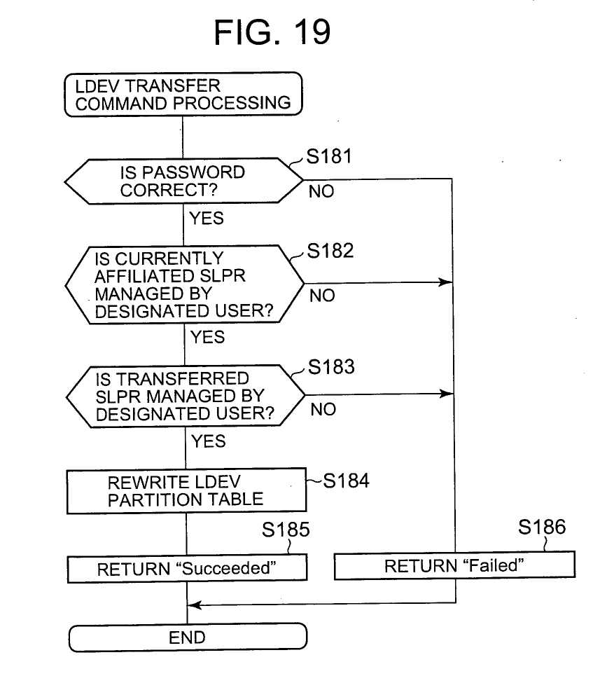

FIG. 19 is a flowchart showing the processing routine to be executed when the maintenance terminal 89 pertaining to another embodiment of the present invention receives the LDEV transfer command from the management computer 69. The LDEV transfer command is a new command to be issued by the management computer 69 against the maintenance terminal 89. With the LDEV transfer command, based on MoveLdevSIpr, the maintenance terminal 89 performs processing for moving the user ID, password, SLPR number, LDEV number, and LDEV designated in this command to the SLPR designated in this command from the SLPR to which they currently belong. Here, the SLPR before transfer and the SLPR after transfer need to be a management target of the user designated (with the storage manager management table, for example). Incidentally, the response of the maintenance terminal 89 to the LDEV transfer command is Succeeded/Failed.

In FIG. 19, foremost, when the maintenance terminal 89 receives the LDEV transfer command transmitted from the management computer 69, it checks to see whether the password transmitted together with the command is authentic (step S181). As a result of this check, when it is judged that the password is authentic (Yes in step S181), it checks to see whether the SLPR to which the LDEV designated in the command currently belongs is being managed by a designated user (step S182). As a result of this check, when it is judged that this SLPR is being managed by a designated user (Yes in step S182), subsequently, it checks to see whether the destination SLPR designated in the command is being managed by a designated user (step S183). As a result of this check, when it is judged that the SLPR is being managed by a designated user (Yes in step S183), the maintenance terminal 89 performs the rewriting processing of the LDEV partition table shown in FIG. 8 (step S184).

Next, the maintenance terminal 89 transmits Succeeded to the management computer 69 as a response to the LDEV transfer command (step S185), and the series of LDEV transfer command processing steps will end.

Incidentally, when it is judged as No in step S181 and step S182, the maintenance terminal 89 transmits Failed to the management computer 69 as a response to the LDEV transfer command (step S186), and the series of LDEV transfer command processing steps will end.

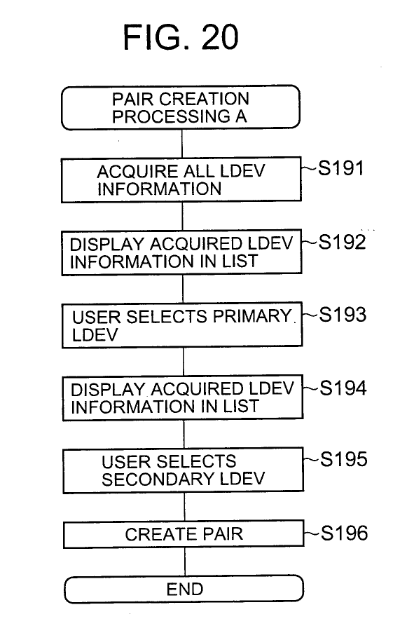

FIG. 20 is a flowchart showing the pair creation processing routine to be implemented when the administrator pertaining to another embodiment of the present invention is to create a local replication pair. The pair creation processing A shown in FIG. 20 is primarily performed in the maintenance terminal upon the administrator creating a local replication pair with the storage management software loaded on the management computer 69.

In FIG. 20, foremost, the administrator performs processing for acquiring all LDEV information regarding all SLPR managed by the administrator. In other words, the administrator, at GetLdevInfo, designates the user ID and password in the user management table (storage manager management table/storage manager management table (A)), designates “all” to the SLPR number, and notifies these designated contents to the maintenance terminal 89. As a result, the maintenance terminal 89 will search and acquire The LDEV number information corresponding to the (number information of the) SLPR from the LDEV partition table shown in FIG. 8 with the (number information of the) SLPR registered as the management target in the user management table (storage manager management table/storage manager management table (A)) as the key. Further, with such LDEV number information as the key, information pertaining to the LDEV corresponding to the LDEV number information from the LDEV management information table shown in FIG. 9 is searched and acquired, and all LDEV information can be obtained thereby (step S191).

Next, the administrator lists all LDEV information acquired in step S191 regarding all SLPR managed by the administrator, and transmits this from the management computer 69 to the maintenance terminal 89. Then, the maintenance terminal 89 which received the foregoing list displays such list on the display (not shown) of the maintenance terminal 89 (step S192). When this list is displayed on the display (not shown) of the maintenance terminal 89, the user designated (in the storage manager management table/storage manager management table (A)) refers to the pair management table stored in the SM 83 (of the DKC 71) shown in FIG. 12, and selects the primary LDEV (step S193). And, the information on the primary LDEV selected by the designated user is made into a list, and displayed on the display (not shown) of the maintenance terminal 89 (step S194).

When this list is displayed on the display (not shown) of the maintenance terminal 89, the designated user selects the secondary LDEV from the displayed list (step S195). And, it issues a local replication pair generation command with the user ID and password (registered in the storage manager management table shown in FIG. 10 or FIG. 11) of the subsystem manager from the selected secondary LDEV and the primary LDEV selected in step S193, and creates a pair of the primary LDEV and secondary LDEV (step S196). As a result, the series of pair creation processing steps will end.

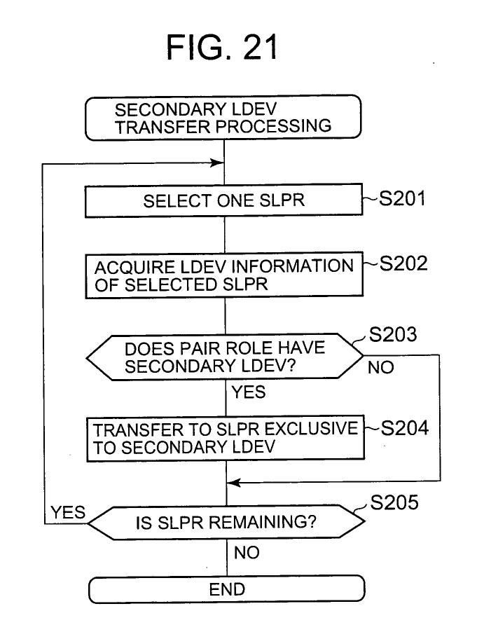

FIG. 21 is a flowchart showing the processing routine of the secondary LDEV transfer processing pertaining to another embodiment of the present invention. The secondary LDEV transfer processing shown in FIG. 21, for example, is automatically performed by the administrator periodically (once an hour) with the storage management software loaded in the management computer 69.

In FIG. 21, the administrator, while referring to the SLPR management table for secondary LDEV shown in FIG. 14 held by the storage management software loaded on the management computer 69, selects one unchecked SLPR from the SLPR other than the SLPR for secondary LDEV (step S201). Next, the administrator acquires information of the LDEV (LDEV information) contained in the SLPR selected in step S201. In other words, the administrator, at GetLdevInfo, designates the user ID and password in the user management table (storage manager management table/storage manager management table (A)), designates the SLPR number selected in step S201 as the SLPR number, and notifies these designated contents to the maintenance terminal 89. As a result, the maintenance terminal 89 will search and acquire LDEV number information corresponding to the (number information of the) SLPR from the LDEV partition table shown in FIG. 8 with the (number information of the) SLPR registered as a management target in the user management table (storage manager management table/storage manager management table (A)) as the key. Further, with such LDEV number information as the key, it searches and acquires information pertaining to LDEV corresponding to the LDEV number information from the LDEV management information table shown in FIG. 9, and all LDEV information can be acquired thereby (step S202).

Next, the administrator checks to see whether the pair role has a secondary LDEV by referring to the LDEV management table stored in the SM 83 (of the DKC 71) from all LDEV information that the maintenance terminal 89 acquired in step S202 (step S203). As a result of this check, when it is judged that the pair role has a secondary LDEV (Yes in step S203), the administrator will perform processing such that the pair role will make the secondary LDEV move to the SLPR exclusive to the secondary LDEV.

In other words, the administrator, with the MoveLdevSIpr command, designates the user ID and password in the user management table (storage manager management table/storage manager management table (A)), designates SLPR exclusive to secondary LDEV to the SLPR number, and notifies these designated contents to the maintenance terminal 89. As a result, in the maintenance terminal 89, processing for making the pair role move the secondary LDEV to the SLPR exclusive to secondary LDEV. Incidentally, when the pair role has a plurality of secondary LDEV, one command (MoveLdevSIpr) is issued for each secondary LDEV (step S204).

The processing routine shown from step S201 through step S204 is continued until there is no longer an unchecked SLPR from the SLPR other than the SLPR for secondary LDEV (No in step S205). And, when it is judged that there is no longer an unchecked SLPR (Yes in step S205), the series of secondary LDEV transfer processing steps will end.

As a result of the secondary LDEV transfer processing shown in FIG. 21 ending, LDEV other than the SLPR exclusive to secondary LDEV (secondary LDEV not belonging to the SLPR exclusive to the secondary LDEV) will be checked by the administrator periodically, and then transferred to the SLPR exclusive to the secondary LDEV.

Although the preferred embodiments of the present invention have been described above, these are merely exemplifications for explaining the present invention, and are not intended to limit the scope of the present invention to such embodiments. The present invention can be implemented in other various modes.

What is claimed is:

1. A storage system management device, comprising:
a first setting unit for setting a first partition containing an active volume among the plurality of partitions of a storage system formed by logically partitioning said storage system;
a second setting unit for setting a second partition containing a candidate of a secondary volume capable of forming a pair with a primary volume, with the active volume as said primary volume, among said plurality of partitions;
a volume information acquisition unit for acquiring information pertaining to a volume contained in said plurality of partitions;
a judgement unit for judging whether the volume is a candidate of the secondary volume contained in said second partition from the information of said volume acquired by said volume information acquisition unit; and
a pair creation unit for extracting a volume capable of making the volume judged by said judgement unit as being contained in said second partition become the secondary volume among the volumes contained in said first partition, and creating a pair with said volume as the primary volume and said judged volume as the secondary volume thereof.

2. A storage system management device according to claim 1, further comprising an access inhibition unit for inhibiting any access to the candidate of the secondary volume contained in said second partition.

3. A storage system management device according to claim 1, wherein none of the volumes contained in said first partition is used as the secondary volume.

4. A storage system management device according to claim 1, further comprising a manager judgement unit for judging whether the manager of said storage system is a higher-level manager capable of managing all of said respective partitions, or a lower-level manager capable of managing only a specific partition among said respective partitions.

5. A storage system management device according to claim 1 or claim 4, wherein, when said manager judgement unit judges the manager of said storage system to be said higher-level manager or the manager of said second partition, said pair creation unit entrusts the selection, from said second partition, of the volume to be said secondary volume of the volume made to be said primary volume, to the top manager who operates the management terminal for managing said storage system.

6. A storage system management device according to claim 5, wherein the extraction of the volume to be said primary volume from said first partition is conducted by said top manager.

7. A storage system management device according to claim 1 or claim 4, wherein, when said manager judgement unit judges the manager of said storage system to be said lower-level manager, said pair creation unit automatically conducts the selection, from said second partition, of the volume to be the secondary volume of the volume made to be said primary volume.

8. A storage system management device according to claim 1, wherein only the manager of said second partition performs the processing of assigning the volume made to be said secondary volume contained in said second partition to a host device which exchange data with said storage device, and the processing of canceling such assignment.

9. A storage system management device, comprising:
a first setting unit for setting a first partition containing an active volume among the plurality of partitions of a storage system formed by logically partitioning said storage system;
a second setting unit for setting a second partition for accommodating, as the secondary volume, a volume capable of forming a pair with a primary volume, with the active volume as the primary volume, among said plurality of partitions;
a volume information acquisition unit for acquiring information pertaining to a volume contained in said plurality of partitions excluding said second partition;
a judgement unit for judging whether there is a volume capable of forming a pair with said active volume among the volume contained in said plurality of partitions excluding said second partition from the information of the volume acquired by said volume information acquisition unit; and
a volume transfer unit for transferring a volume judged by said judgement unit to be capable of forming a pair to said second partition as the secondary volume when said active volume is made to be the primary volume.

10. A storage system management method, comprising:
a first step of setting a first partition containing an active volume among the plurality of partitions of a storage system formed by logically partitioning said storage system;
a second step of setting a second partition containing a candidate of a secondary volume capable of forming a pair with a primary volume, with the active volume as the primary volume, among said plurality of partitions;
a third step of acquiring information pertaining to all volumes contained in said plurality of partitions;
a fourth step of judging whether the volume is a candidate of the secondary volume contained in said second partition from the information of volume acquired in the third step; and
a fifth step of extracting a volume capable of making the volume judged in the fourth step as being contained in said second partition become the secondary volume among the volumes contained in said first partition, and creating a pair with said volume as the primary volume and said judged volume as the secondary volume thereof.
